(19) United States
(12) Patent Application Publication
(10) Pub. No.: US 2013/0082530 A1
(43) Pub. Date: Apr. 4, 2013

(54) RENEWABLE ENERGY GENERATION SYSTEM

(71) Applicant: Sheng-Hua LI, Taoyuan Hsien (TW)

(72) Inventor: Sheng-Hua LI, Taoyuan Hsien (TW)

(21) Appl. No.: 13/613,330

(22) Filed: Sep. 13, 2012

(30) Foreign Application Priority Data
Sep. 29, 2011 (CN) 201110295445.3

(51) Int. Cl. H02J 9/00

(52) U.S. Cl. 307/64

(57) ABSTRACT

A renewable energy generation system is provided, including at least one renewable energy generator, at least one micro-inverter and an uninterruptible power supply. The renewable energy generator generates a DC power source. The micro-inverter is coupled to the renewable energy generator to convert the DC power source to an AC power source according to a utility power. The uninterruptible power supply is coupled to the micro-inverter, in which the uninterruptible power supply provides a reference voltage to the micro-inverter when the utility power is cut off, such that the micro-inverter continually provides the AC power source to at least one loading according to the reference voltage generated by the uninterruptible power supply.

### CROSS REFERENCE TO RELATED APPLICATIONS

This Application claims priority of China Patent Application No. 201110295445.3, filed on Sep. 29, 2011, the entirety of which is incorporated by reference herein.

### BACKGROUND

1. Field of the Disclosure

The present disclosure relates to a renewable energy generation system, and in particular relates to a grid tied energy generation system.

2. Description of the Related Art

Although renewable energy plays a small role among the world's electricity sources, however, limited fossil fuels and the side effect of the fossil fuels for the environment, has lead to increased importance in the development of renewable energy technologies. Therefore, the use of renewable energy is a way to replace fossil fuels.

In general, the present renewable energy generation system is a grid tied energy generation system. The kinds of solar energy generation systems can be divided into two energy generation systems. One of the energy generation systems is a centralized solar energy generation system. The other is a distributed solar energy generation system. Compared with the centralized solar energy generation system, the distributed solar energy generation system is weatherproof and has higher reliability and greater expandability. However, the centralized solar energy generation system and the distributed solar energy generation system sometimes provide power abnormally because of some external factors. Therefore, there is a need for an energy generation system to overcome defects of the current designs.

### BRIEF SUMMARY

The problem of the grid tied energy generation system is that the solar energy generation system stops providing power when the utility power serving thereto, as reference foundation, is cut off. In order to solve this problem, the disclosure uses an uninterruptible power supply to provide a reference voltage to a micro-inverter when the utility power is cut off, thereby preventing the solar energy generation system from failure to provide power.

In light of the previously described problems, the invention provides an embodiment of a renewable energy generation system, comprising at least one renewable energy generator, at least one micro-inverter and an uninterruptible power supply. The renewable energy generator generates a DC power source. The micro-inverter is coupled to the renewable energy generator to convert the DC power source to an AC power source according to a utility power. The uninterruptible power supply is coupled to the micro-inverter, in which the uninterruptible power supply provides a reference voltage to the micro-inverter when the utility power is cut off, such that the micro-inverter continually provides the AC power source to at least one loading according to the reference voltage generated by the uninterruptible power supply.

An embodiment further discloses a power generation method, capable of a renewable energy generation system having at least one renewable energy generator, at least one micro-inverter and an uninterruptible power supply. The power generation method includes the steps of: detecting a utility power provided to the micro-inverter; providing a reference voltage to the micro-inverter when the utility power is cut off; and continually converting a DC power source generated by the renewable energy generator into an AC power source by the micro-inverter according to the reference voltage.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1 illustrates a schematic view of the renewable energy generation system of the disclosure;

FIG. 2 illustrates an embodiment of the renewable energy generation system of the disclosure; and

FIG. 3 illustrates a flowchart of the power generation method of the disclosure capable of the renewable energy generation system 100.

### DETAILED DESCRIPTION

The embodiment will be explained as follows. The following description is made for the purpose of illustrating the embodiment and should not be taken in a limiting sense. The scope of the invention is best determined by reference to the appended claims.

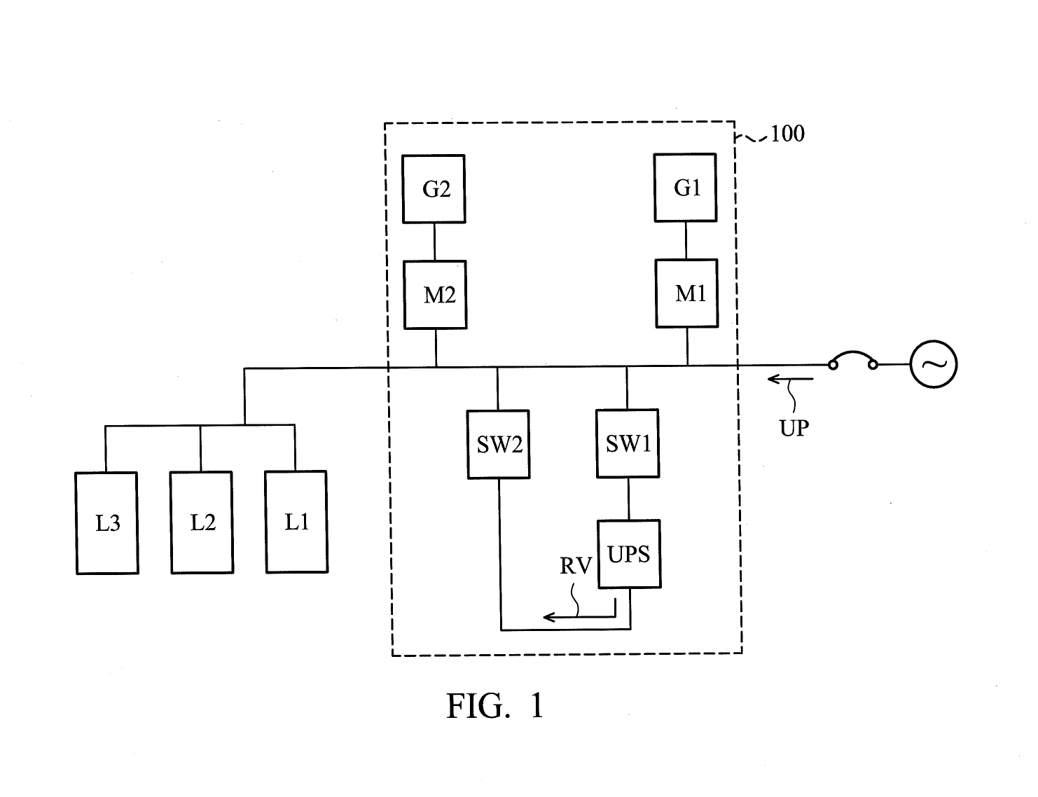

FIG. 1 illustrates a schematic view of the renewable energy generation system of the disclosure. As shown in FIG. 1, the renewable energy generation system 100 generates an AC power source according to a utility power UP. The renewable energy generation system 100 includes at least one micro-inverter M1 or M2, at least one renewable energy generator G1 or G2, an uninterruptible power supply UPS and switching units SW1 and SW2, in which the quantities of the micro-inverter and the renewable energy generator is provided for illustration, but are not limited thereto. In addition, the renewable energy generators G1 and G2 are respectively coupled to the micro-inverters M1 and M2, such that the micro-inverters M1-M2 convert the DC power source generated by the renewable power generators G1 and G2 into the AC power source, thereby providing the AC power source to at least one loading (e.g. loadings L1˜L3). The loadings L1˜L3 can be any of various kinds of electronic devices, for example, lamps, televisions or computer. In the embodiments, the renewable energy generators G1 and G2 can be wind turbines or solar power generators, but are not limited thereto. Any device generating renewable energy can be the renewable energy generator of the disclosure. In general, the micro-inverters M1˜M2 convert the DC power source into the AC power source according to the utility power UP. Therefore, the micro-inverters M1 and M2 cannot convert the DC power source into the AC power source when the utility power UP is cut off.

The switching unit SW1 is coupled between the input terminal of the uninterruptible power supply UPS and micro-inverters M1 and M2, and the switching unit SW2 is coupled between the output terminal of the uninterruptible power supply UPS and micro-inverters M1 and M2, such that the reference voltage RV is provided to the micro-inverters M1 and M2 when the utility power UP is cut off, thereby the micro-inverters M1 and M2 provide the AC power source to the loadings L1-L3 according to the reference voltage RV generated by the uninterruptible power supply UPS, in which the reference voltage RV is a sinusoidal wave voltage

In detail, when the utility power UP is provided normally, the switching unit SW1 operates in the close circuit state and the switching unit SW2 operates in the open circuit state, such that the AC power source, generated by the micro-inverters M1 and M2, and/or the utility power UP charges the uninterruptible power supply UPS. When the utility power UP is cut off, the switching unit SW1 operates in the open circuit state and the switching unit SW2 operates in the close circuit state, such that the uninterruptible power supply UPS provides the reference voltage RV to the micro-inverters M1 and M2 through the switching unit SW2. Thus, the micro-inverters M1 and M2 continently convert the DC power source into the AC power source according to the reference voltage RV and provide the AC power source to the loadings L1-L3.

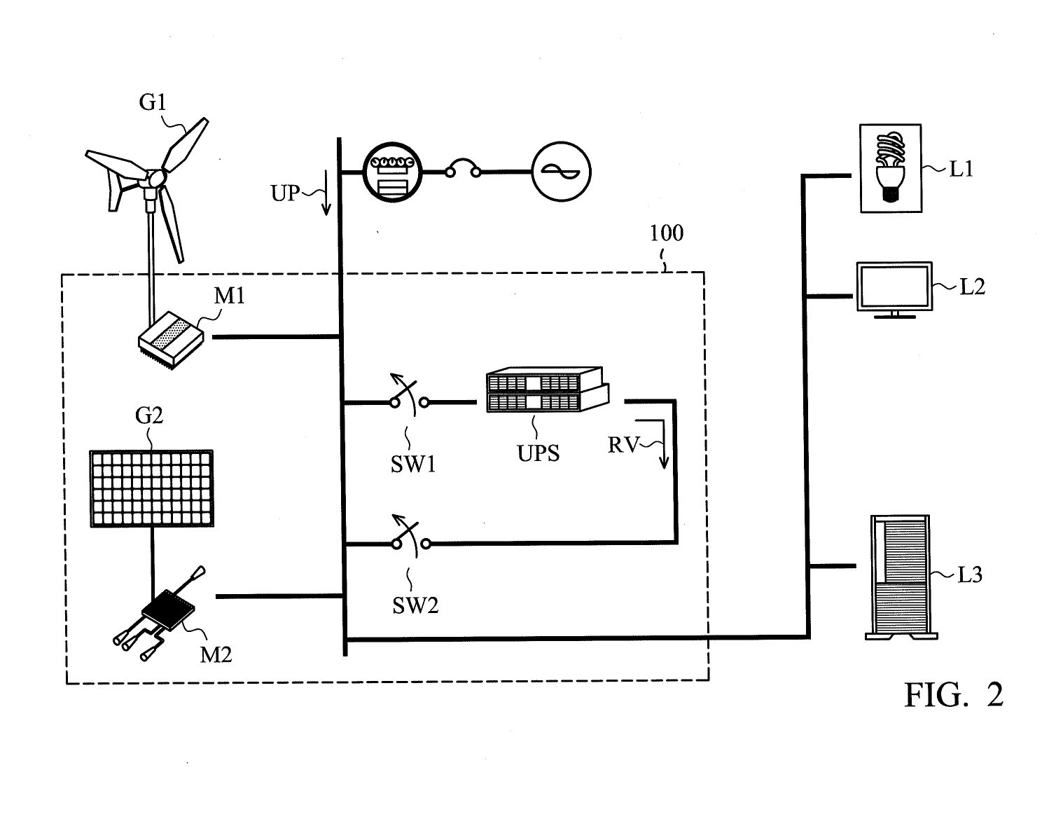

FIG. 2 illustrates an embodiment of the renewable energy generation system of the disclosure. As shown in FIG. 2, the renewable energy generators G1 and G2 are a wind turbine and a solar power generator, respectively. The loadings L1-L3 are a lamp, a television and a computer, respectively. The operating procedures of the switching units SW1 and SW2 and the uninterruptible power supply UPS are shown in FIG. 1 and are described above, therefore, the operating procedures are omitted here for brevity. Since the renewable energy generation system 100 has the uninterruptible power supply UPS, the renewable energy generation system 100 can continually provide the AC power source to loadings L1˜L3 when the utility power UP is cut off. In some embodiments, the power generated by the uninterruptible power supply UPS would be larger than the total power of the all loadings and the total power of the all loadings would be larger than the maximum power (i.e., total power) which the renewable energy generation system 100 can generate.

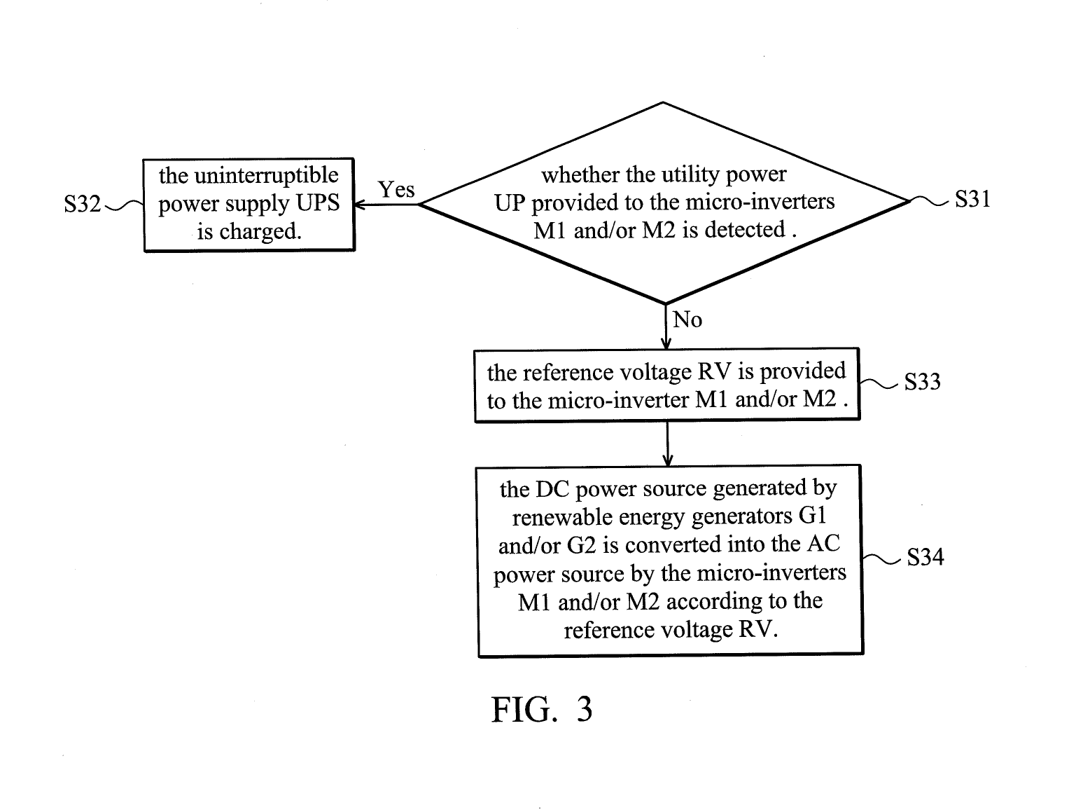

FIG. 3 illustrates a flowchart of the power generation method of the disclosure capable of the renewable energy generation system 100. As shown in FIG. 3, the power generation method includes the following steps.

In step S31, whether the utility power UP provided to the micro-inverters M1 and/or M2 is detected. For example, the uninterruptible power supply UPS or an external host has a processing unit to detect whether the utility power is cut off, but is not limited thereto. When the utility power UP is provided normally, the procedure enters step S32, and the uninterruptible power supply UPS is charged. When the utility power UP is cut off, the procedure enters step S33, and the reference voltage RV is provided to the micro-inverter M1 and/or M2. In step S34, the DC power source generated by renewable energy generators G1 and/or G2 is converted into the AC power source by the micro-inverters M1 and/or M2 according to the reference voltage RV.

In detail, in step S32, the switching unit SW1 is turned on when the utility power UP is provided normally, such that the AC power source generated by the micro-inverters M1 and M2 and/or the utility power UP charges the uninterruptible power supply UPS. In step S33, the switching unit SW1 is turned off and the switching unit SW1 is turned on when the utility power UP is cut off, thereby providing the reference voltage RV to the micro-inverters M1 and M2, in which the switching unit SW1 is coupled between the input terminal of the uninterruptible power supply UPS and the micro-inverters M1 and M2, and the switching unit SW2 is coupled between the output terminal of the uninterruptible power supply UPS and the micro-inverters M1 and M2.

In conclusion, with the renewable energy generation system and power generation method of the disclosure, the micro-inverters M1 and M2 can generate the AC power source (i.e., grid tied energy generation system) when the utility power UP operates normally. The micro-inverters M1 and M2 can generate the AC power source according to the reference voltage RV when the utility power UP disappears, such that the renewable energy generation system 100 continually provides the AC power source. In addition, the uninterruptible power supply UPS stores redundant energy to protect the power consumption when solar power generators and/or wind turbines generate enough energy.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A renewable energy generation system, comprising:
at least one renewable energy generator, generating a DC power source;
at least one micro-inverter, coupled to the renewable energy generator to convert the DC power source into a AC power source according to an utility power; and
an uninterruptible power supply, coupled to the micro-inverter,
wherein the uninterruptible power supply provides a reference voltage to the micro-inverter when the utility power is cut off, such that the micro-inverter continually provides the AC power source to at least one loading according to the reference voltage generated by the uninterruptible power supply.

2. The renewable energy generation system as claimed in claim 1, further comprising:
a first switching unit, coupled between an input terminal of the uninterruptible power supply and the micro-inverter; and
a second switching unit, coupled between an output terminal of the uninterruptible power supply and the micro-inverter,
wherein, when the utility power is cut off, the first switching unit operates in an open circuit state and the second switching unit operates in a close circuit state, such that the uninterruptible power supply provides the reference voltage to the micro-inverter through the second switching unit.

3. The renewable energy generation system as claimed in claim 2, wherein, when the utility power is provided normally, the first switching unit operates in the close circuit state, such that the uninterruptible power supply is charged by the utility power and/or the AC power source generated by the micro-inverter.

4. The renewable energy generation system as claimed in claim 1, wherein the renewable energy generator is a solar power generator and/or a wind turbine.

5. The renewable energy generation system as claimed in claim 1, wherein the reference voltage is a sinusoidal wave voltage.

6. A power generation method, capable of a renewable energy generation system having at least one renewable energy generator, at least one micro-inverter and an uninterruptible power supply, comprising:
detecting whether a utility power is provided to the micro-inverter;
providing a reference voltage to the micro-inverter when the utility power is cut off; and
continually converting a DC power source generated by the renewable energy generator into an AC power source by the micro-inverter according to the reference voltage.

7. The power generation method as claimed in claim 6, comprising:
turning off a first switching unit and turning on a second switching unit when the utility power is cut off, thereby providing the reference voltage to the micro-inverter, wherein the first switching unit is coupled between a input terminal of the uninterruptible power supply and the micro-inverter, and the second switching unit is coupled between an output terminal of the uninterruptible power supply and the micro-inverter.

8. The power generation method as claimed in claim 7, further comprising turning on the first switching unit when the utility power is provided normally, such that the uninterruptible power supply is charged by the utility power and/or the AC power source generated by the micro-inverter.

9. The power generation method as claimed in claim 6, wherein the renewable energy generator is a solar power generator and/or a wind turbine.

10. The power generation method as claimed in claim 6, wherein the reference voltage is a sinusoidal wave voltage.
